(19) United States
(12) Patent Application Publication
(10) Pub. No.: US 2014/0363073 A1
(43) Pub. Date: Dec. 11, 2014

(54) HIGH-PERFORMANCE PLANE DETECTION WITH DEPTH CAMERA DATA

(71) Applicant: Microsoft Corporation, Redmond, WA (US)

(72) Inventors: Grigor Shirakyan, Kirkland, WA (US); Mihai R. Jalobeanu, Sammamish, WA (US)

(21) Appl. No.: 13/915,618

(22) Filed: Jun. 11, 2013

(51) Int. Cl. G06T 7/00

(52) U.S. Cl. CPC G06T 7/0075
USPC 382/154

(57) ABSTRACT

The subject disclosure is directed towards detecting planes in a scene using depth data of a scene image, based upon a relationship between pixel depths, row height and two constants. Samples of a depth image are processed to fit values for the constants to a plane formulation to determine which samples indicate a plane. A reference plane may be determined from those samples that indicate a plane, with pixels in the depth image processed to determine each pixel's relationship to the plane based on the pixel's depth, location and associated fitted values, e.g., below the plane, on the plane or above the plane.

### BACKGROUND

Detecting flat planes using a depth sensor is a common task in computer vision. Flat plane detection has many practical uses ranging from robotics (e.g., distinguishing the floor from obstacles during navigation) to gaming (e.g., depicting an augmented reality image on a real world wall in a player's room).

Plane detection is viewed as a special case of a more generic surface extraction family of algorithms, where any continuous surface (including, but not limited to a flat surface) is detected on the scene. Generic surface extraction has been performed successfully using variations of RANSAC (RANdom Sampling And Consensus) algorithm. In those approaches, a three-dimensional (3D) point cloud is constructed, and the 3D scene space is sampled randomly. Samples are then evaluated for belonging to the same geometrical construct (e.g., a wall, or a vase). Plane detection also has been performed in similar manner.

One of the main drawbacks to using these existing methods for plane detection is poor performance. 3D point clouds need to be constructed from every frame, and only then can sampling begin. Once sampled, points need to be further analyzed for belonging to a plane on a 3D scene. Furthermore, to classify any pixel in a depth frame as belonging to the plane, the pixel needs to be placed into the 3D point cloud scene, and then analyzed. This process is expensive in terms of computational and memory resources.

The need to construct a 3D point cloud adds significant algorithmic complexity to solutions when what is really needed is only detecting a relatively few simple planes (e.g., a floor, shelves, and the like). Detecting and reconstructing simple planes in depth sensor's view such as a floor, walls, or a ceiling using naïve 3D plane fitting methods fail to take advantage of the properties of camera-like depth sensors.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, one or more of various aspects of the subject matter described herein are directed towards processing depth data of an image to determine a plane. One or more aspects describe using a plurality of strips containing pixels to find values for each strip that represent how well that strip's pixels fit a plane formulation based upon pixel depth values and pixel locations in the depth data corresponding to the strip. Values for at least some strips that indicate a plane are maintained, based on whether the values meet an error threshold indicative of a plane. Sets of the maintained values are associated with sets of pixels in the depth data.

One or more aspects include plane extraction logic that is configured to produce plane data for a scene. The plane extraction logic inputs frames of depth data comprising pixels, in which each pixel has a depth value, column index and row index, and processes the frame data to compute pairs of values for association with the pixels. For each pixel, its associated pair of computed values, its depth value and its row or column index indicate a relationship of that pixel to a reference plane.

One or more aspects are directed towards processing strips of pixel depth values, including for each strip, finding fitted values that fit a plane formula based upon row height and depth data for pixels of the strip. The fitted values for any strip having pixels that do not correspond to a plane are eliminated based upon a threshold evaluation that distinguishes planar strips from non-planar strips. Of those non-eliminated strips, which ones of the strips are likely on a reference plane is determined. The fitted values of the strips that are likely on the reference plane are used to associate a set of fitted values with each column of pixels.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing example components that may be used to compute plane data from a two-dimensional (2D) depth image according to one or more example implementations.

FIG. 2 is a representation of an example of a relationship between a depth camera's view plane, a distance to a plane, a row height, and a camera height, that may be used to compute plane data according to one or more example implementations.

FIG. 3 is a representation of how sampling strips (patches) of depth data corresponding to a captured image may be used to detect planes, according to one or more example implementations.

FIG. 4 is a representation of how row heights and distances relate to a reference plane (e.g., a floor), according to one or more example implementations.

FIG. 5 is a representation of how sampling strips (patches) of depth data corresponding to a captured image may be used to detect planes and camera roll, according to one or more example implementations.

FIG. 6 is a flow diagram representing example steps that may be taken to determine a reference plane by processing 2D depth data, according to one or more example implementations.

FIG. 7 is a block diagram representing an exemplary non-limiting computing system or operating environment, in the form of a gaming system, into which one or more aspects of various embodiments described herein can be implemented.

### DETAILED DESCRIPTION

Various aspects of the technology described herein are generally directed towards plane detection without the need for building a 3D point cloud, thereby gaining significant computational savings relative to traditional methods. At the same time, the technology achieves high-quality plane extraction from the scene. High performance plane detection is achieved this by taking advantage of specific depth image properties that a depth sensor (e.g., such as using Microsoft Corporation's Kinect™ technology) produces when a flat surface is in the view.

In general, the technology is based on applying an analytical function that describes how a patch of flat surface ‘should’ look like when viewed by a depth sensor that produces a 2D pixel representation of distances from objects on the scene to a plane of view (that is, a plane that is perpendicular to the center ray entering the sensor at a right angle).

As described herein, a patch of flat surface when viewed from a such a depth sensor has to fit a form:

Depth=B/(RowIndex−A)

(or D=B/(H−A), where H is the numerical index of the pixel row; for example, on a 640×480 depth image, the index can go from 1 to 480). Depth, or D is the distance to the sensed obstacle measured at pixel row (H), and A and B are constants describing a hypothetical plane that goes through an observed obstacle. The constant A can be interpreted as a “first pixel row index at which the sensor sees infinity, also known as the “horizon index.” B can be interpreted as a “distance from the plane.” Another way to interpret A and B is to state that A defines the ramp of the plane as viewed from the sensor, and B defines how high the sensor is from the surface it is looking at; for a floor, B corresponds to the camera height above the floor.

Described herein is an algorithm that finds the A and B constants from small patches of a depth-sensed frame, thus providing for classifying the rest of the depth frame pixels as being ‘on the plane’, ‘under the plane’ or ‘above the plain’ with low computational overhead compared to point cloud computations. The above-described analytical representation offers an additional benefit of being able to define new planes (e.g., a cliff or ceiling) in terms of planes that have already been detected (e.g., floor), by manipulating the A and/or B constants. For example, if the A and B constants have been calculated for a floor as seen from a mobile robot, to classify obstacles of only certain height or higher, the values of B and/or A constants may be changed by amounts that achieve desired classification accuracy and precision.

Thus, the technology described herein detects planes in depth sensor-centric coordinate system. Additional planes may be based on modifying A and/or B of an already detected surface. Further, the technology provides for detecting tilted and rolled planes by varying A and/or B constants, width and/or height-wise.

It should be understood that any of the examples herein are non-limiting. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in plane detection, depth sensing and image processing in general.

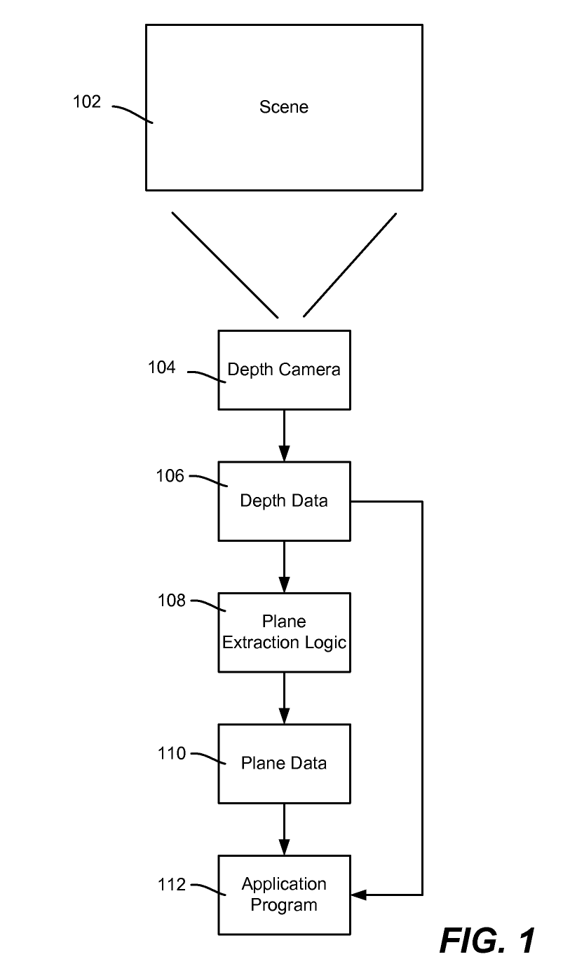

FIG. 1 exemplifies a general conceptual block diagram, in which a scene 102 is captured by a depth camera 104 in one or more sequential frames of depth data 106. The camera 104 may comprise a single sensor, or multiple (e.g., stereo) sensors, which may be infrared and/or visible light (e.g., RGB) sensors. The depth data 106 may be obtained by time-of-flight sensing and/or stereo image matching techniques. Capturing of the depth data may be facilitated by active sensing, in which projected light patterns are projected onto the scene 102.

The depth data 106 may be in the form of an image depth map, such as an array of pixels, with a depth value for each pixel (indexed by a row and column pair). The depth data 106 may or may not be accompanied by RGB data in the same data structure, however if RGB data is present, the depth data 106 is associated with the RGB data via pixel correlation.

As described herein, plane extraction logic 108 processes the depth data 106 into plane data 110. In general, the plane data 110 is generated per frame, and represents at least one reference plane extracted from the image, such as a floor. Other depths in the depth image/map and/or other planes may be relative to this reference plane.

The plane data 110 may be input to an application program 112 (although other software such as an operating system component, a service, hardcoded logic and so forth may similarly access the plane data 110). For example, an application program 112 may determine for any given pixel in the depth data 106 whether that pixel is on the reference plane, above the reference plane (e.g., indicative of an obstacle) or below the reference plane (e.g., indicative of a cliff).

For purposes of explanation herein, the reference plane will be exemplified as a floor unless otherwise noted. As can be readily appreciated, another reference plane, such as a wall, a ceiling, a platform and so forth may be detected and computed.

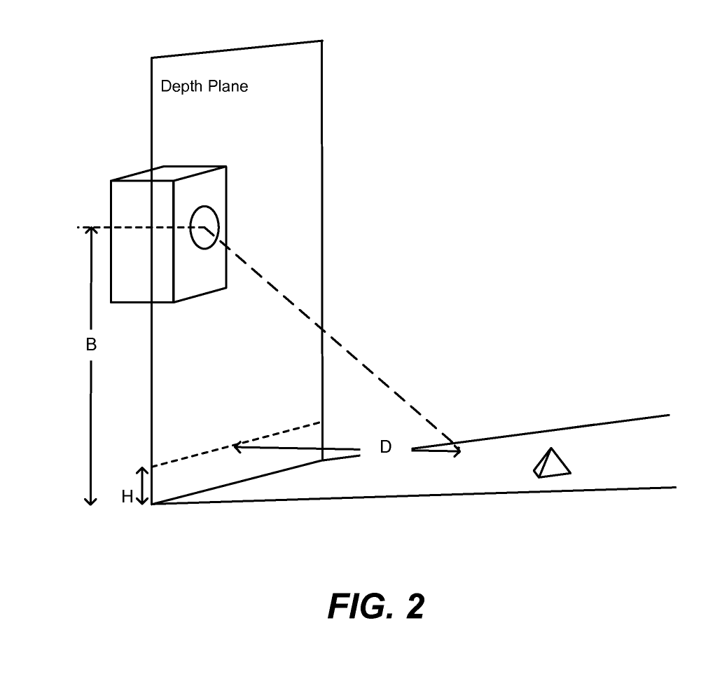

As set forth above and generally represented in FIG. 2 (in which D represents to Depth and H represents RowIndex, the distance to floor from a horizontally positioned depth sensor's view plane for each row index is hereby described using the formula:

Depth=B/(RowIndex−A)

If it is a plane, the depth sensed is a function of the height (B) of the camera above the plane, and the row index (H), considering the slope of the floor relative to the camera, where the A constant defines how sloped the floor is and the B constant defines how much it is shifted in Z-direction (assuming the sensor is mounted at some height off the ground). Note that in depth data, D (and thus the row index H) is computed from an image plane of the camera, not the camera sensor's distance.

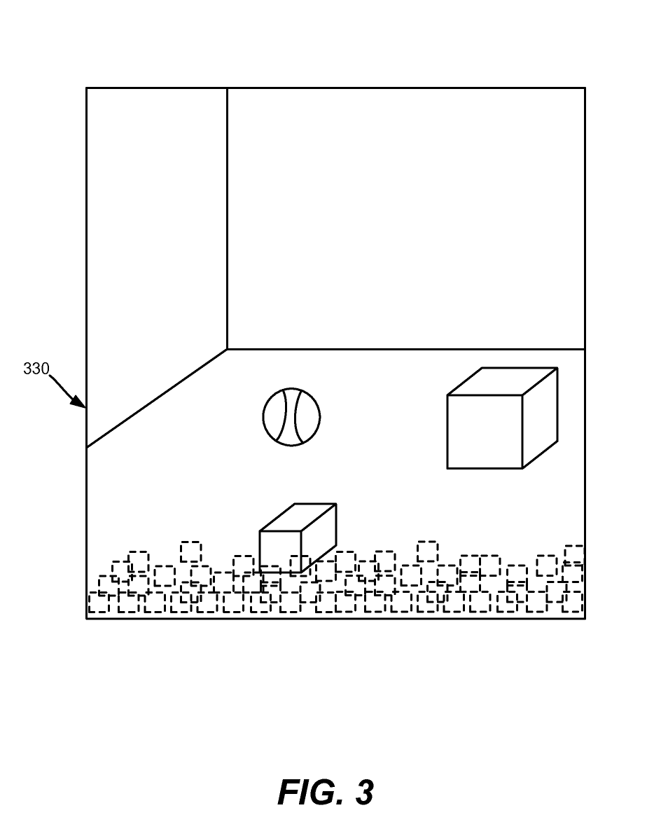

In general, A and B are not known. In one implementation, the dynamic floor extraction method analyzes small patches (called strips) across the width (the pixel columns) of the depth frame, varying A and B trying to fit the above formula to those strips. The concept of patches is generally represented in FIG. 3, where a two-dimensional image 330 is shown; the strips comprise various 2D samples of the depth data, and are represented as dashed boxes near and across the bottom of the image 330; the strips may or may not overlap in a given implementation. Note that in actuality, the depth image data is not of visible objects in a room as in the image 330, but rather there are numeric depth values at each pixel. Thus, it is understood that the strips are filled with their respective pixels' depth values, not RGB data. Further, note that for floor detection, e.g., from a mobile robot, the strips are placed at the bottom of the frame as in FIG. 3; however for tabletop extraction the strips are randomly scattered across the entire frame. Still further, note that the shape, number, distribution, sizes and/or the like of the depicted strips relative to the “image” 330 are solely for purposes of a visible example, and not intended to convey any actual values. In general, however, plane detection benefits from having strips extend across the width of the image, and the number of pixels in each strip need to be sufficient to try to detect whether the sample is part of a plane or not. As can be readily appreciated, the more samples taken the more information is available, however there is a tradeoff between the number of samples taken versus the amount of computation needed to process the samples.

In general, a strip can have any width and height. Increasing the width and height of the strip has the effect of smoothing noise in the input depth data. In practice, a relatively small number of large strips is good for floor detection, and a relatively large number of smaller strips is more applicable to detecting a tabletop on a cluttered scene. For example, sixteen strips of 10×48 may be used for floor detection, while one hundred 2×24 strips may be used for tabletop detection.

By way of example, consider floor extraction in the context of robot obstacle avoidance and horizontal depth profile construction. In this scenario, the extraction process tries to learn the A and B coefficients for each strip across the frame, and with the A and B values, calculates a cutoff plane that is slightly higher than the projected floor. Knowing that plane, the process can then mark pixels below the projected floor as the “floor” and everything above it as an obstacle, e.g., in the plane data 110. Note that everything below the “floor” beyond some threshold value or the like alternatively may be considered a cliff.

To calculate best fitting A and B constant values for any given strip, the process may apply a least squared approximation defined by the formula:

$$f = {\sum }_{i = 1}^{m} {( {Y}_{i} - \frac{B}{( {X}_{i} - A )} )}^{2} \to min$$

The process needs to differentiate by A and B and seeks:

$$\frac{\partial f}{\partial A} = 0$$

$$and$$

$$\frac{\partial f}{\partial A} = 0.$$

Differentiating by A and B gives:

$$B = \frac{{\sum }_{i = 1}^{m} \frac{{Y}_{i}}{{X}_{i} - A}}{{\sum }_{i = 1}^{m} \frac{1}{{( {X}_{i} - A )}^{2}}}$$

$$A = {\sum }_{i = 1}^{m} ( {Y}_{i} - \frac{B}{( {X}_{i} - A )} ) * \frac{1}{{( {X}_{i} - A )}^{2}} = 0$$

The constant A may be found by any number of iterative approximation methods; e.g., the Newton-Raphson method states:

$${x}_{n + 1} = {x}_{n} - \frac{f ( {x}_{n} )}{{f}^{′} ( {x}_{n} )} .$$

This may be solved via a complex algorithm. Alternatively, the process may use a simpler (although possibly less efficient) binary search of A by computing squared errors and choosing each new A in successively smaller steps until the process reaches a desired precision. Controlling the precision of searching for A is a straightforward way to tweak the performance of this learning phase of the algorithm.

At runtime, with each depth frame, the A and B may be learned for all strips. Along with calculating A and B, a ‘goodness of fit’ measure is obtained that contains the square error result of fitting a strip to the best possible A and B for that strip. If a strip is not looking at the floor in this example, the error is large, and thus strips that show a large error are discarded. Good strips, however, are kept. The measure of ‘goodness’ may be an input to the algorithm, and may be based on heuristics and/or adjusted to allow operation in any environment, e.g., carpet, hardwood, asphalt, gravel, grass lawn, and so on are different surfaces that may be detected as planes, provided the goodness threshold is appropriate.

Because there may be a number of flat surfaces on the scene, there is a task of distinguishing between such surfaces from fitted As and Bs. This is straightforward, given that A and B constants that fit the same plane are very close. The process can prune other planes using standard statistical techniques, e.g., by variance. The process can also employ any number of heuristics to help narrow the search. For example, if the task for a plane fitting is to detect a floor from a robot that has a fixed depth sensor at a given height, the process can readily put high and low limits on the B constant.

Once the strips across the depth frame width have been analyzed, the process produces a pair of A and B constants for every width pixel (column) on the depth frame (e.g., via linear interpolation). Depending on the pan/tilt/roll of the camera, there may be a virtually constant A and B across the frame width, or A and B values may change across the frame width. In any event, for every column of pixels, there is a pair of A and B constants that may be used later when classifying pixels.

Although the A and B pairs are generally recomputed per frame, if a scene becomes so cluttered that the process cannot fit a sufficient number of strips to planes, then the A and B constants from the previous frame may be reused for the current frame. This works for a small number of frames, except when A and B cannot be computed because the scene is so obstructed that not enough of the floor is visible (and/or the camera has moved, e.g., rolled/tilted too much over the frames).

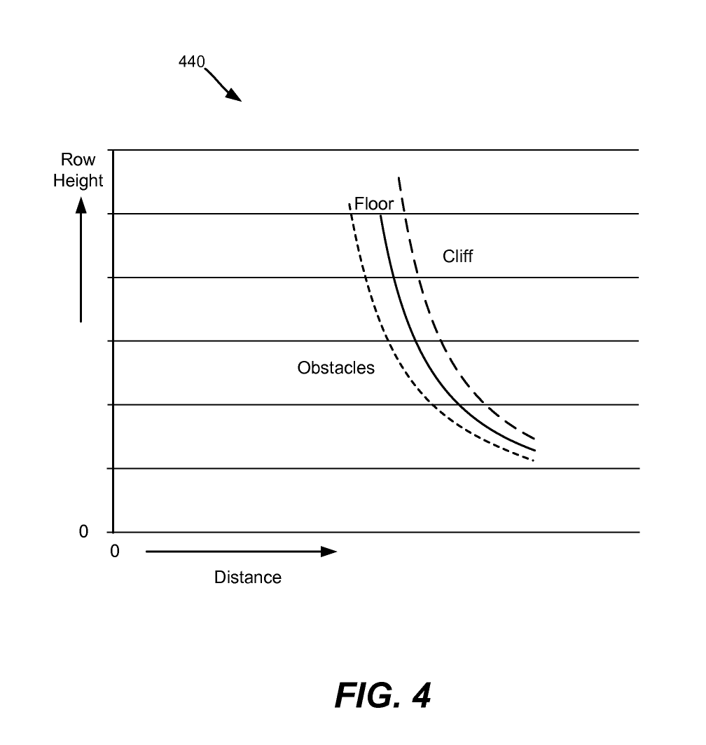

FIG. 4 represents a graph 440, in which the solid center line represents how per-row depth readings from a depth sensor appear when there is a true floor plane in front of the camera (the X axis represents the distance from the sensor, the Y axis represents the pixel row). The dashed lines (obstacles and cliff) are obtained by varying the A constant. Once the lines are defined mathematically, it is straightforward to compute B/(X−A) with B and A constant values from the graph (or appropriate A and B values found in a lookup table or the like) to classify any pixel's plane affinity for a column X. Note that varying A has an effect of tilting the camera up and down, which is the property used at runtime to learn and extract the floor dynamically.

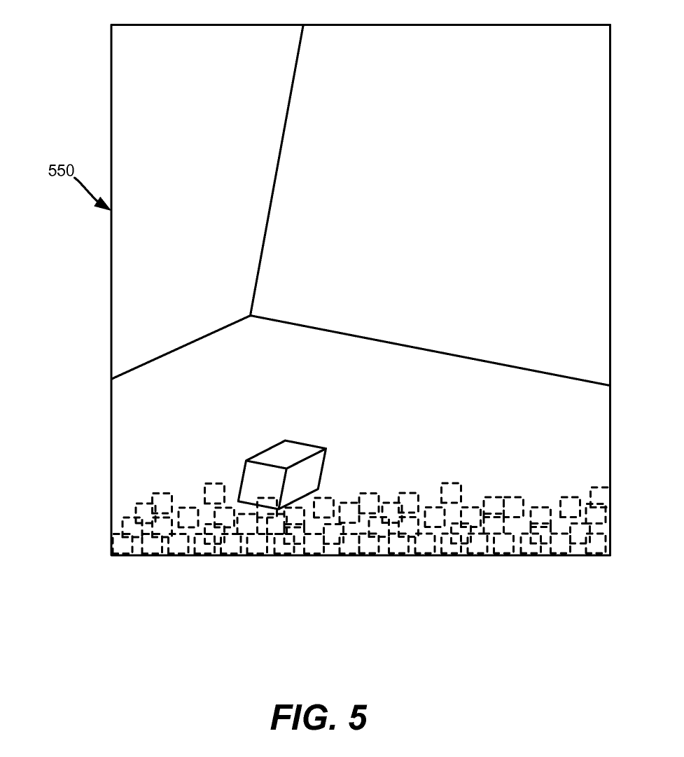

FIG. 5 shows an image representation 550 with some camera roll (and some slight tilt) relative to the image 440 of FIG. 4. As can be seen, the slope of the floor changes, and thus the values of the A constants vary across the image's columns. The difference in the A constants' values may be used to determine the amount of roll, for example.

Because the process may use only a small sampling region in the frame to find the floor, the process does not incur much computational cost to learn the A and B constants for the entire depth frame width. However, to classify a pixel as floor/no floor, the process has to inspect each pixel, computing two integer math calculations and table lookups. This results in a relatively costly transformation, but is reasonably fast.

In addition to determining the floor, the same extraction process may be used to find cliffs, which need no additional computation, only an adjustment to A and/or B). Ceilings similarly need no additional computation, just an increase to B. Vertical planes such as walls may be detected using the same algorithm, except applied to columns instead of row.

Additional slices of space, e.g., parallel to the floor or arbitrarily tilted/shifted relative to the floor also may be processed. This may be used to virtually slice a 3D space in front of the camera without having to do any additional learning.

Moreover, surface quality is already obtainable without additional cost as surface quality is determinable from the data obtained while fitting the strips of pixels. For example, the smaller the error, the smoother the surface. Note that this may not be transferable across sensors for example, because of differing noise models; (unless the surface defects are so large that they are significantly more pronounced than the sensors' noise).

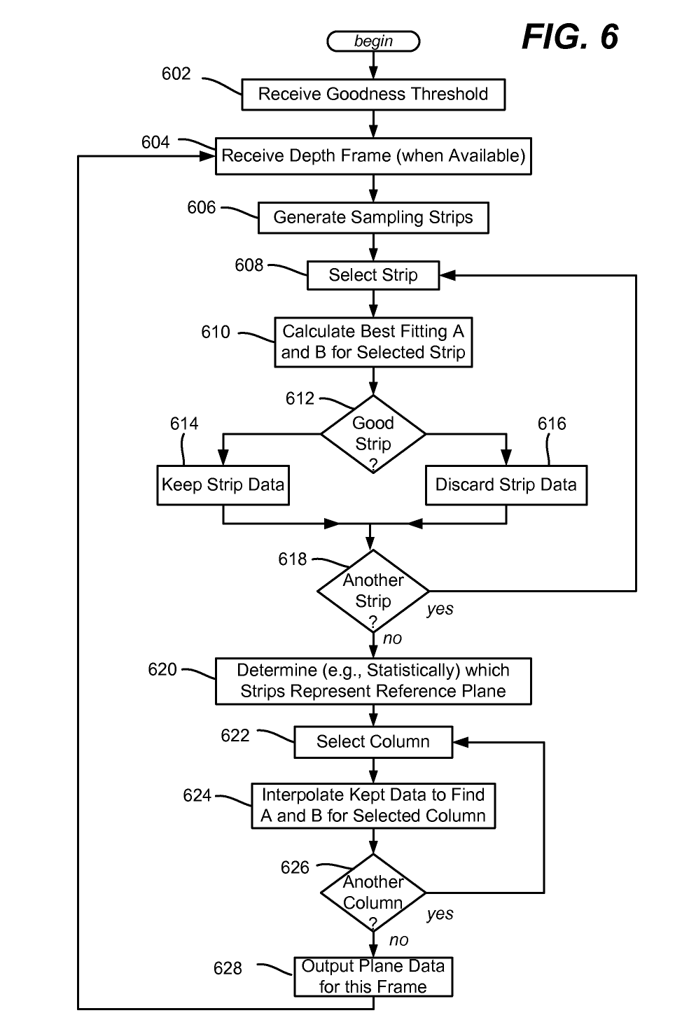

FIG. 6 is a flow diagram summarizing some example steps of the extraction process, beginning at step 602 where the “goodness” threshold is received, e.g., the value that is used to determine whether a strip is sufficiently planar to be considered part of a plane. In some instances, a default value may be used instead of a variable parameter.

Step 604 represents receiving the depth frame, when the next one becomes available from the camera. Step 606 generates the sampling strips, e.g., pseudo-randomly across the width of the depth image.

Each strip is then selected (step 608) processed to find the best A and B values that fit strip data to the plane formula described herein. Note that some of these steps may be performed in parallel to the extent possible, possibly on a GPU/in GPU memory.

Step 610 represents the fitting process for the selected strip. Step 612 evaluates the error against the goodness threshold to determine whether the strip pixels indicate a plane (given the threshold, which can be varied by the user to account for surface quality), whereby the strip data is kept (step 614). Otherwise the data of this strip is discarded (step 616). Step 618 repeats the fitting process until completed for each strip.

Step 620 represents determining which strips represent the reference plane. More particularly, as described above, if detecting a floor, for example, many strips may represent planes that are not on the floor; these may be distinguished (e.g., statistically) based on their fitted A and B constant values, which differ from the (likely) most prevalent set of A and B constant values that correspond to strips that captured the floor.

Using the A and B values for each remaining strip, steps 622, 624 and 626 determine the A and B values for each column of pixels, e.g., via interpolation or the like. Note that if a vertical plane is the reference plane, steps 622, 624 and 626 are modified to deal with pixel rows instead of columns.

Step 628 represents outputting the plane data. For example, depending on how the data is used, this may be in the form of sets of A, B pairs for each column (or row for a vertical reference plane). Alternatively, the depth map may be processed into another data structure that indicates where each pixel lies relative to the reference plane, by using the depth and pixel row of each pixel along with the A and B values associated with that pixel. For example, if the reference plane is a floor, then the pixel is approximately on the floor, above the floor or below the floor based upon the A and B values for that pixel's column and the pixel row and computed depth of that pixel, and a map may be generated that indicates this information for each frame.

As set forth above, it is possible that the image is of a surface that is too cluttered for the sampling to determine the A, B values for a reference plane. Although not shown in FIG. 6, this may be determined by having too few strips remaining following step 620 to have sufficient confidence in the results, for example. As mentioned above, this may be handled by using the A, B values from a previous frame. Another alternative is to resample, possibly at a different area of the image, (e.g., slightly higher because the clutter may be in one general region), provided sufficient time remains to again fit and analyze the re-sampled strips.

As can be seen, the technology described herein provides an efficient way to obtain plane data from a depth image without needing any 3D (e.g., point cloud) processing. The technology may be used in various applications, such as to determine a floor and obstacles thereon (and/or cliffs relative thereto).

### Example Operating Environment

It can be readily appreciated that the above-described implementation and its alternatives may be implemented on any suitable computing device, including a gaming system, personal computer, tablet, DVR, set-top box, smartphone and/or the like. Combinations of such devices are also feasible when multiple such devices are linked together. For purposes of description, a gaming (including media) system is described as one exemplary operating environment hereinafter.

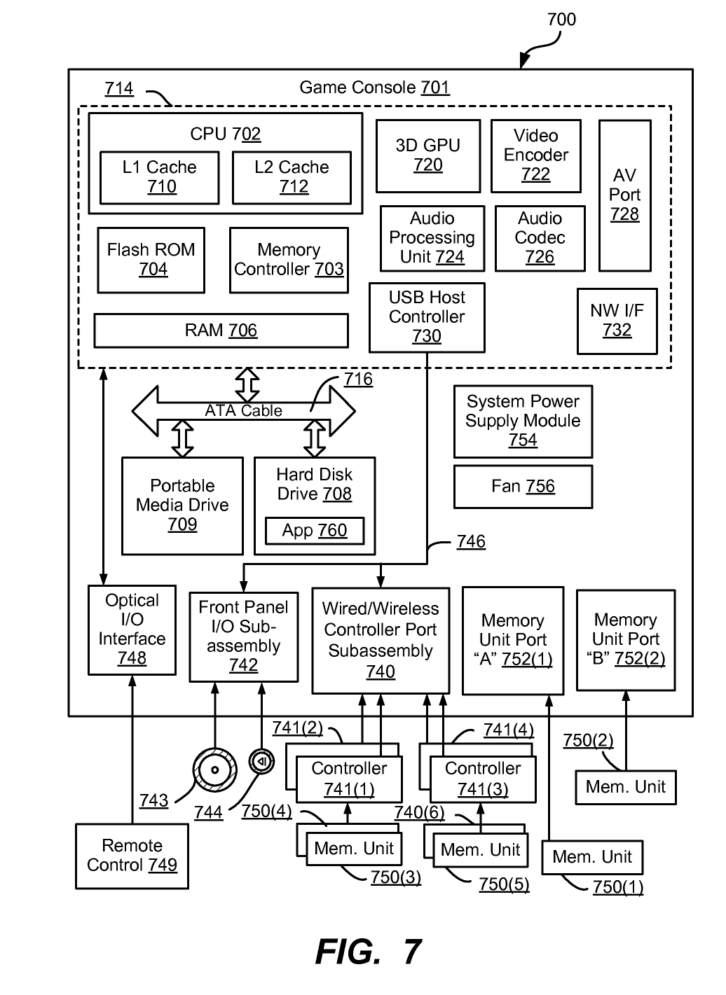

FIG. 7 is a functional block diagram of an example gaming and media system 700 and shows functional components in more detail. Console 701 has a central processing unit (CPU) 702, and a memory controller 703 that facilitates processor access to various types of memory, including a flash Read Only Memory (ROM) 704, a Random Access Memory (RAM) 706, a hard disk drive 708, and portable media drive 709. In one implementation, the CPU 702 includes a level 1 cache 710, and a level 2 cache 712 to temporarily store data and hence reduce the number of memory access cycles made to the hard drive, thereby improving processing speed and throughput.

The CPU 702, the memory controller 703, and various memory devices are interconnected via one or more buses (not shown). The details of the bus that is used in this implementation are not particularly relevant to understanding the subject matter of interest being discussed herein. However, it will be understood that such a bus may include one or more of serial and parallel buses, a memory bus, a peripheral bus, and a processor or local bus, using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

In one implementation, the CPU 702, the memory controller 703, the ROM 704, and the RAM 706 are integrated onto a common module 714. In this implementation, the ROM 704 is configured as a flash ROM that is connected to the memory controller 703 via a Peripheral Component Interconnect (PCI) bus or the like and a ROM bus or the like (neither of which are shown). The RAM 706 may be configured as multiple Double Data Rate Synchronous Dynamic RAM (DDR SDRAM) modules that are independently controlled by the memory controller 703 via separate buses (not shown). The hard disk drive 708 and the portable media drive 709 are shown connected to the memory controller 703 via the PCI bus and an AT Attachment (ATA) bus 716. However, in other implementations, dedicated data bus structures of different types can also be applied in the alternative.

A three-dimensional graphics processing unit 720 and a video encoder 722 form a video processing pipeline for high speed and high resolution (e.g., High Definition) graphics processing. Data are carried from the graphics processing unit 720 to the video encoder 722 via a digital video bus (not shown). An audio processing unit 724 and an audio codec (coder/decoder) 726 form a corresponding audio processing pipeline for multi-channel audio processing of various digital audio formats. Audio data are carried between the audio processing unit 724 and the audio codec 726 via a communication link (not shown). The video and audio processing pipelines output data to an A/V (audio/video) port 728 for transmission to a television or other display/speakers. In the illustrated implementation, the video and audio processing components 720, 722, 724, 726 and 728 are mounted on the module 714.

FIG. 7 shows the module 714 including a USB host controller 730 and a network interface (NW I/F) 732, which may include wired and/or wireless components. The USB host controller 730 is shown in communication with the CPU 702 and the memory controller 703 via a bus (e.g., PCI bus) and serves as host for peripheral controllers 734. The network interface 732 provides access to a network (e.g., Internet, home network, etc.) and may be any of a wide variety of various wire or wireless interface components including an Ethernet card or interface module, a modem, a Bluetooth module, a cable modem, and the like.

In the example implementation depicted in FIG. 7, the console 701 includes a controller support subassembly 740, for supporting four game controllers 741(1)-741(4). The controller support subassembly 740 includes any hardware and software components needed to support wired and/or wireless operation with an external control device, such as for example, a media and game controller. A front panel I/O subassembly 742 supports the multiple functionalities of a power button 743, an eject button 744, as well as any other buttons and any LEDs (light emitting diodes) or other indicators exposed on the outer surface of the console 701. The subassemblies 740 and 742 are in communication with the module 714 via one or more cable assemblies 746 or the like. In other implementations, the console 701 can include additional controller subassemblies. The illustrated implementation also shows an optical I/O interface 748 that is configured to send and receive signals (e.g., from a remote control 749) that can be communicated to the module 714.

Memory units (MUs) 750(1) and 750(2) are illustrated as being connectable to MU ports “A” 752(1) and “B” 752(2), respectively. Each MU 750 offers additional storage on which games, game parameters, and other data may be stored. In some implementations, the other data can include one or more of a digital game component, an executable gaming application, an instruction set for expanding a gaming application, and a media file. When inserted into the console 701, each MU 750 can be accessed by the memory controller 703.

A system power supply module 754 provides power to the components of the gaming system 700. A fan 756 cools the circuitry within the console 701.

An application 760 comprising machine instructions is typically stored on the hard disk drive 708. When the console 701 is powered on, various portions of the application 760 are loaded into the RAM 706, and/or the caches 710 and 712, for execution on the CPU 702. In general, the application 760 can include one or more program modules for performing various display functions, such as controlling dialog screens for presentation on a display (e.g., high definition monitor), controlling transactions based on user inputs and controlling data transmission and reception between the console 701 and externally connected devices.

The gaming system 700 may be operated as a standalone system by connecting the system to high definition monitor, a television, a video projector, or other display device. In this standalone mode, the gaming system 700 enables one or more players to play games, or enjoy digital media, e.g., by watching movies, or listening to music. However, with the integration of broadband connectivity made available through the network interface 732, gaming system 700 may further be operated as a participating component in a larger network gaming community or system.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A method, comprising, processing depth data of an image to determine a plane, in which the depth data includes indexed rows and columns of pixels and a depth value for each pixel, including using a plurality of strips containing pixels, finding values for each strip that represent how well that strip's pixels fit a plane formulation based upon depth values and pixel locations in the depth data corresponding to the strip, maintaining the values for at least some strips that indicate a plane based on whether the values meet an error threshold indicative of a plane, and associating sets of the maintained values with sets of pixels in the depth data.

2. The method of claim 1 wherein the plane is a reference plane, and wherein maintaining the values for at least some strips that indicate a plane comprises keeping the values for strips that correspond to the reference plane and not any other plane.

3. The method of claim 1 wherein the sets of pixels correspond to columns of pixels, and wherein associating the sets of the maintained values with the sets of pixels comprises associating a per-column set of the values with column of pixels.

4. The method of claim 3 further comprising, for a given pixel having a depth value, a column identifier and a row identifier in the depth data, using the depth value, the values associated with the pixel's column, and the row identifier to estimate whether that pixel lies a) below the plane or above the plane, or b) on the plane, below the plane or above the plane.

5. The method of claim 3 further comprising using a change in one of the values across the columns to determine an amount of camera roll.

6. The method of claim 3 further comprising, interpolating a plurality of values corresponding to a column to find the values for associating with a selected column.

7. The method of claim 1 wherein the sets of values are determined for a frame, and further comprising reusing the constant values for a subsequent frame.

8. The method of claim 1 wherein finding the values for each strip comprises determining at least one of the values by iterative approximation.

9. The method of claim 1 wherein finding the values for each strip comprises determining at least one of the values by determining one of the constants by a binary search.

10. The method of claim 1 wherein the error threshold comprises a variable parameter, and further comprising, receiving the error threshold from an external source.

11. The method of claim 1 wherein processing the depth data of an image to determine a plane comprises determining a floor.

12. The method of claim 11 further comprising determining a substantially horizontal surface other than the floor based upon using the floor as a reference plane.

13. The method of claim 1 wherein processing the depth data of an image to determine a plane comprises determining a substantially vertical plane.

14. The method of claim 1 wherein using the strips comprises sampling a region with the plurality of strips.

15. The method of claim 1 wherein one of the values corresponds to a camera height relative to the plane, and wherein finding the values for each strip comprises constraining one of the values to be within a range of possible camera heights.

16. A system comprising, plane extraction logic configured to produce plane data for a scene, the plane extraction logic configured to input frames of depth data comprising pixels in which each pixel has a depth value, column index and row index, process the frame data to compute pairs of values for association with the pixels, in which for each pixel, a pair of values for the pixel, the depth value of the pixel, and the row or column index of the pixel indicate a relationship of that pixel to a reference plane.

17. The system of claim 16 wherein the reference plane is substantially horizontal, and wherein the pair of values for the pixel is associated with the pixel's column index, and the pair of values for the pixel, the depth value of the pixel, and the row index of the pixel indicate a relationship of that pixel to the reference plane.

18. The system of claim 16 plane extraction logic processes the depth data by sampling strips of pixels to fit a pair of values to each strip.

19. One or more machine-readable storage media or logic having executable instructions, which when executed perform steps, comprising:
processing strips of pixel depth values, including for each strip, finding fitted values that fit a plane formula based upon row height and depth data for pixels of the strip;
eliminating the fitted values for any strip having pixels that do not correspond to a plane based upon a threshold evaluation that distinguishes planar strips from non-planar strips;
determining from non-eliminated strips which of the non-eliminated strips are likely on a reference plane; and
using the fitted values of the strips that are likely on the reference plane to associate a set of fitted values with each column of pixels.

20. The one or more machine-readable storage media or logic of claim 19 having further executable instructions comprising determining, for at least one pixel, a relationship between the pixel and the reference plane based upon the depth value of the pixel, a row height of the pixel and the set of fitted values associated with a column of the pixel.
